(19) United States
(12) Patent Application Publication
(10) Pub. No.: US 2026/0078993 A1
(43) Pub. Date: Mar. 19, 2026

(54) Systems and Tools for Obtaining and Visualizing Positions and Measurements Through Obstructions

(71) Applicant: MONLIZ LLC, Sacramento, CA (US)

(72) Inventors: Robert Monaghan, Ventura, CA (US); Jai Singh, Como (IT)

(73) Assignee: MONLIZ LLC, Sacramento, CA (US)

(21) Appl. No.: 18/889,508

(22) Filed: Sep. 19, 2024

(51) Int. Cl. G01B 3/1069; G01S 5/02

(52) U.S. Cl. CPC G01B 3/1069; G01S 5/0294

(57) ABSTRACT

A system, device, and associated methods are disclosed for obtaining and visualizing positions and measurements through obstructions. The device receives signaling from a wireless transceiver that is moved to different positions within an obscured pathway or space. The device converts the signaling into three-dimensional (3D) positions based on properties of the signaling changing upon arrival at the device from the different positions, and maps the 3D positions to corresponding positions about an image or a 3D model of the obscured pathway or space. The device presents a visualization of the 3D path at positions about an image or model of the obstructed pathway or space that correspond to the measured positions.

### BACKGROUND

The path of a conduit, piping, or other connected pathway that is located in a wall, ground, or otherwise sealed off from view or obstructed cannot be accurately determined without exposing the connected pathway for visual inspection or by using expensive X-ray or other surface penetrating technology. Fishing lines or tapes may be used to measure the distance of the connected pathway and/or to run wiring through the connected pathway. However, they do not reveal the exact shape, turns, and bends of the connected pathway and cannot be used to accurately map the three-dimensional positioning of the connected pathway within the wall, ground, or other structure.

Measuring tapes, electronic range finders, and/or laser measurement devices are also of little or no value for measurements that do not have an unobstructed or direct line-of-sight. For instance, the devices cannot be used to measure through a wall or provide accurate measurements for different segments of a connected pathway that is obstructed from view.

### BRIEF DESCRIPTION OF THE DRAWINGS

FIG. 1 illustrates an example of a measurement device in accordance with some embodiments presented herein.

FIG. 2 illustrates an example of tracking a three-dimensional (3D) path through an obstructed pathway in accordance with some embodiments presented herein.

FIG. 3 presents a process for tracking the 3D positions of the measurement device in an obstructed pathway or space in accordance with some embodiments.

FIG. 4 illustrates an example of supplementing a measured 3D path with additional measurements in accordance with some embodiments presented herein.

FIG. 5 presents a process for improving the measurement accuracy based on different measurements produced by different sensors of the measurement device in accordance with some embodiments presented herein.

FIG. 6 illustrates an example of an enhanced visualization of a mapped 3D path through an obscured pathway or space in accordance with some embodiments presented herein.

FIG. 7 illustrates an example of using different measurement devices to calculate a single value for a space in accordance with some embodiments presented herein

FIG. 8 illustrates example components of one or more devices, according to one or more embodiments described herein.

### DETAILED DESCRIPTION OF PREFERRED EMBODIMENTS

The following detailed description refers to the accompanying drawings. The same reference numbers in different drawings may identify the same or similar elements.

Provided are systems and tools for obtaining and visualizing positions and measurements through obstructions. Specifically, a measurement system includes a measurement device and associated methods for measuring positions of the measurement device in three-dimensions as the measurement device is moved through an enclosed or obstructed pathway or space, generating a three-dimensional (3D) path based on the measured positions, and presenting a visualization of the 3D path at positions about an image or model of the obstructed pathway or space that correspond to the measured positions.

The measurement device includes a multi-antenna Ultra-WideBand (UWB) transceiver that is attached to a distal end of a physical extendible line. In some embodiments, the measurement device includes a second UWB transceiver and/or other sensors on the proximal end of the measurement device and/or a housing from which the extendible physical line extends. The measurement device may be a modified or enhanced fish tape or measuring tape.

The UWB transceiver periodically emits signaling that penetrates through various obstructions. The signaling is received by the measurement device or a separate user device and is converted into a 3D positional measurement. In some embodiments, the measurement device or the user device generates azimuth, distance, and altitude measurements from the signaling which may specify an exact vertical, horizontal, and depth offset of the UWB transceiver relative to the device receiving the signaling and performing the signaling-to-3D position conversion. Accordingly, the measurement devices or the user device may track the position of the extendible line with the UWB transceiver in three dimensions as they are extended through an obstructed pathway or space. The user device may generate a virtual reality, augmented reality, mixed reality, or other enhanced reality presentation of the UWB transceiver path based on the tracked 3D positioning. For instance, the user device may present the 3D position of the UWB transceiver within an obstructed pathway or space on a live or recorded view of the obstructed pathway or space or on a 3D model of the obstructed pathway or space. A user may follow the path of the UWB transceiver while the UWB transceiver is hidden or obstructed from view in the obstructed pathway or space.

Other sensors of the measurement device may be used to improve the accuracy of the tracked 3D path or to provide accurate distance, angle, and/or other measurements for any segment of the tracked 3D path. For instance, the other sensors may measure, with millimeter or centimeter accuracy, the amount by which the extendible line is extended from the housing for each of the tracked 3D positional measurements.

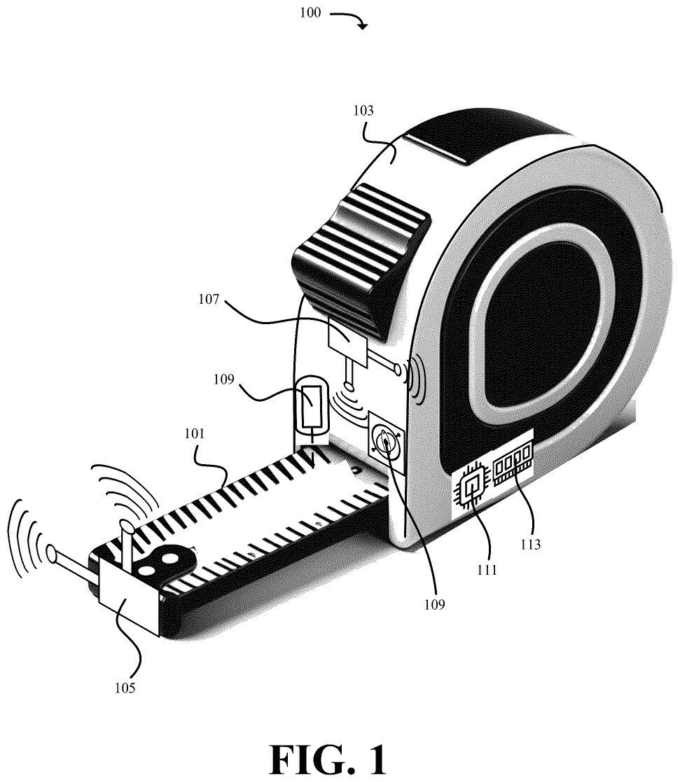

FIG. 1 illustrates an example of measurement device 100 in accordance with some embodiments presented herein. Measurement device 100 includes extendible line 101, housing 103, first UWB sensor 105 located on the distal end of extendible line 101, second UWB sensor 107 located at an opening of housing 103 through which extendible line 101 is extended, and sensors 109.

Extendible line 101 may include a semi-rigid material that bends or flexes at different points where force is applied onto the extendible line 101 but that otherwise reverts to a straight or flat shape when the force is removed. In some embodiments, extendible line 101 is made of steel, fiberglass, plastic, and/or other materials commonly used for measuring tapes, fish tapes, or wire feeding or pulling.

Extendible line 101 is spooled within housing 103. Depending on the application, housing 103 may contain 20-200 hundred feet of extendible line 101. Housing 103 may include a spring that retracts extendible line 101 into housing 103 when no pull force is exerted on extendible line 101, and a sliding lock mechanism to retain any amount of extendible line 101 that is fed out of housing 103 and to stop the spring from retracting extendible line 101.

First UWB sensor 105 includes a multi-antenna UWB transceiver. For instance, a first antenna of first UWB sensor 105 may be oriented about a first axis and a second antenna of first UWB sensor 105 may be oriented about a second axis and may be offset from the first antenna. The multi-antenna UWB transceiver generates signaling that penetrates through wood, metal, concrete, cement, stucco, glass, and/or other materials and that may be processed by a receiving device to generate a 3D position via azimuth, distance, and altitude measurements that are derived from signal properties. The signaling may correspond to a low frequency carrier that has periodic spikes. In some embodiments, the multi-antenna UWB transceiver may emit the signaling at a specific rate. For instance, the signaling may be emitted one time per second so that a receiving device may derive a new 3D positional measurement every second. In some other embodiments, the signal emission frequency may be more or less or may be configured with inputs provided from a wirelessly paired user device.

First UWB sensor 105 includes a power source such as a battery and a configurable power driver that adjusts an amount of power provided to the multi-antenna UWB transceiver. The configurable power driver may be used to adjust the signal strength and/or activate and deactivate first UWB sensor 105 to prevent unnecessary depletion of the power source when measurement device 100 is not in use.

Second UWB sensor 107 may be an optional sensor or component of measurement device 100. When included as part of measurement device 100, second UWB sensor 107 emits signaling for a secondary 3D positional measurement of measurement device 100. The secondary 3D positional measurement may be used to establish the position of measurement device 100 as first UWB sensor 105 and extendible line 101 are fed through an obstructed pathway or space. The angle, bend, tilt, and/or other positional attributes of extendible line 101 or of the obstructed pathway or space may be determined by comparing the 3D position of first UWB sensor 105 to the 3D position of second UWB sensor 107. The different 3D positions may also aid in visualizing measurement device 100 when it is behind one or more obstructions and/or in creating a live enhanced reality presentation of measurement device 100 and/or the 3D path of first UWB sensor 105 through an obstructed pathway or space. For instance, measurement device 100 may be placed and extended on one side of a wall to a desired height, distance, or position, and may be viewed from the other side of the wall based on the 3D positions determined for first UWB sensor 105 and second UWB sensor 107 via the signaling emitted from each sensor 105 and 107.

In some embodiments, second UWB sensor 107 may be used to receive the signaling emitted by first UWB sensor 105 and to determine the 3D position of first UWB sensor 105 relative to second UWB sensor 107 and/or measurement device 100 based on the properties of the received signaling. In some such embodiments, measurement device 100 may include processor 111 to locally convert the received signaling from first UWB sensor 105 into a 3D positional measurement and memory 113 to store a 3D path based on different 3D positional measurements that are generated when measurement device 100 is on or activated.

Sensors 109 provide different measurements for supplementing or enhancing the 3D positional measurements obtained from the signaling of first UWB sensor 105 and/or second UWB sensor 107. For instance, the 3D positional measurements obtained from the signaling of first UWB sensor 105 may be accurate to within 10 centimeters when the signaling is obstructed by various materials. To improve the accuracy, sensors 109 may include a laser or an encoder that accurately measures an amount of extendible line 101 that is fed out of housing 103 to within a few millimeters.

In some embodiments, sensors 109 include a gyroscope, thermometer, accelerometer, inertial measurement unit (IMU), and/or compass. In some such embodiments, sensors 109 may track the orientation, direction, and/or rotation of measurement device 100 and aid in determining any bends or curves in extendible line 101 as it is fed through a closed conduit or pipe or in determining the angle or tilt of extendible line 101 when various 3D positions are measured.

In some embodiments, sensors 109 include a Global Positioning System (GPS) radio. The GPS radio may be used to synchronize clocks or obtain accurate timestamps when a GPS signal is available. Additionally, the GPS radio may be used to track the position of measurement device 100.

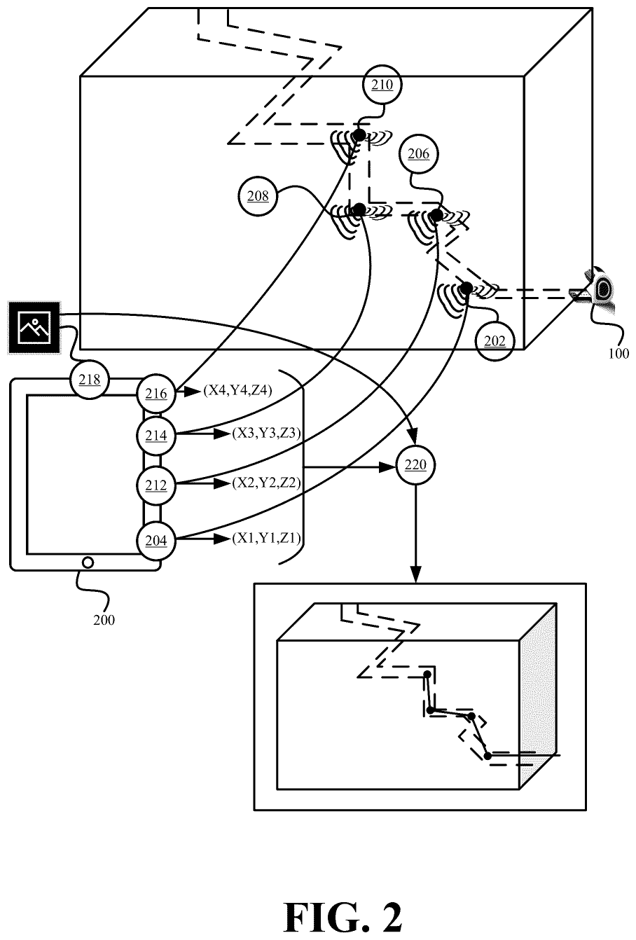

FIG. 2 illustrates an example of tracking a 3D path through an obstructed pathway in accordance with some embodiments presented herein. First UWB sensor 105 emits (at 202) first signaling one measurement device 100 is activated and/or used to track the 3D path through a conduit that runs through a wall. User device 200 receives the first signaling, processes the received signal, and calculates (at 204) the first 3D position based on the angle of arrival, time difference of arrival, time of arrival, and/or other properties associated with the first signaling once it is received by user device 200.

First UWB sensor 105 emits (at 206, 208, and 210) the signaling from different positions in the conduit as extendible line 101 is fed into the conduit. User device 200 receives the additional signaling and converts (at 212, 214, and 216) the additional signaling to additional 3D positions based on different properties with which the signaling arrives at user device 200 when emitted (at 206, 208, and 210) from the different positions from within the wall.

User device 200 captures (at 218) an image of the wall that the conduit passes through and that obstructs a view of the conduit. User device captures (at 218) the image using a camera. In some embodiments, user device 200 captures (at 218) a live video feed of the wall. In some embodiments, user device 200 retrieves a 3D model of the wall that was constructed by scanning the wall or performing a photogrammetry imaging of the wall.

User device 200 may also use a depth sensor to determine its position relative to the wall. For instance, user device 200 may have a Light Detection and Ranging (LiDAR) that may be used to determine the distance between user device 200 and the imaged wall.

User device 200 modifies the image or the 3D model of the wall to present (at 220) a tracked 3D path of first UWB sensor 105 through the conduit using the 3D positions derived from the received signaling. For instance, user device 200 maps the derived or measured 3D positions to corresponding positions in the image or the 3D model. More specifically, user device 200 determines its position relative to the imaged wall and presents a visualization for the determined 3D positions of first UWB sensor 105 relative to user device 200 on the captured (at 218) image. The resulting visualization does not simply plot an x and y position or a vertical and horizontal offset position for first UWB sensor 105 on the image or 3D model. Rather, the resulting visualization presents the different positions for first UWB sensor 105 across three dimensions. In particular, user device 200 modifies the image or the 3D model to present (at 220) each tracked position of first UWB sensor 105 with a horizontal and vertical offset and a depth within the wall. The visualization may include connecting lines between the tracked positions to visually illustrate the 3D path. In this manner, the user can see the 3D path of the conduit in the wall without having to expose the conduit within the wall for visual inspection. The sampling rate or the rate at which first UWB sensor 105 emits the signaling may be increased in order to obtain additional 3D measurements and a more accurate plotting of the 3D path within the wall.

The visualized 3D path may be used for a multitude of purposes. Construction workers and utility companies may reference the visualized 3D path to avoid damaging buried or hidden conduits, pipes, and/or lines within the wall, ground, or other structures that obstruct the view of the conduit. Similarly, architects may reference the visualized 3D path to generate accurate models of exposed and unexposed structures and to draw up plans for remodeling or construction that may reuse or that does not damage the hidden conduits, pipes, and/or lines.

The visualized 3D path and/or measured 3D positions also allow a user to see into walls, the ground, and/or other obstructed surfaces without expensive surface penetrating radar or other technologies. More specifically, the user is presented with a real-time visualization for the position of first UWB sensor 105 behind a wall, in the ground, or within an obstructed space. With this ability to see through the obstructed surfaces, the user may perform work that requires precision or perfect alignment. For instance, the user may need to expose a particular part of a wall where a junction box is located. The user may use measurement device 100 to identify or mark the location of the junction box in the wall, and may begin exposing the portion of the wall covering the junction box based on the 3D position from measurement device 100 identifying or marking the junction box location from the inside of the wall.

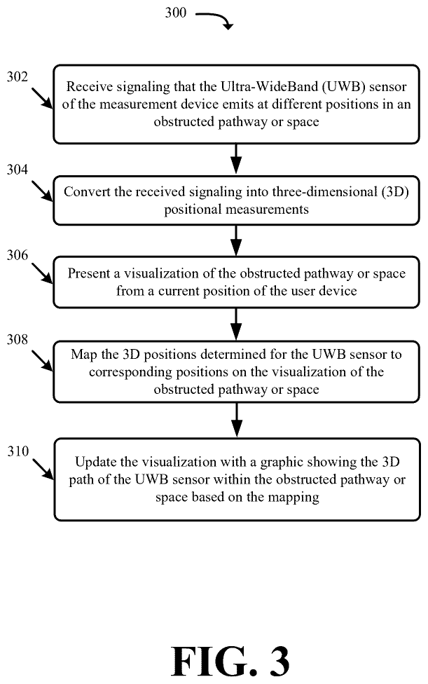

FIG. 3 presents a process 300 for tracking the 3D positions of measurement device 100 in an obstructed pathway or space in accordance with some embodiments. Process 300 is implemented by the measurement system that includes measurement device 100 and a user device. The user device may include a desktop computer, laptop, tablet, smartphone, enhanced reality headset or other spatial computing device, and/or other devices for receiving and converting the signaling from first UWB sensor 105 of measurement device 100 into a set of tracked 3D positions and for generating the visualization of the 3D path through an obstructed pathway or space based on a mapping of the set of tracked 3D positions to an image or model of the obstructed pathway or space.

Process 300 includes receiving (at 302) signaling that first UWB sensor 105 emits at different positions in the obstructed pathway or space as the distal end of extendible line 101 of measurement device 100 is fed into the obstructed pathway or space over time. The properties of the signal emitted from first UWB sensor 105 change as they reflect, deflect, and/or penetrate the obstructed pathway or space before reaching the user device.

Process 300 includes converting (at 304) the received (at 302) signaling into 3D positional measurements. For instance, the UWB communications protocol defines methods for converting the angle of arrival, time difference of arrival, time of arrival, and/or other measured properties of the received (at 302) signaling into measures of azimuth, distance, and altitude. The measures of azimuth, distance, and altitude specify a position of first UWB sensor 105 relative to a position of the user device receiving (at 302) the signaling. In some embodiments, the measures of azimuth, distance, and altitude may be converted to x, y, and z positional coordinates or to values that specify a vertical, horizontal, and depth offsets.

In some embodiments, the emitted signals may be received (at 302) and converted (at 304) on measurement device 100. For instance, second UWB sensor 107 may receive (at 302) the signaling emitted from first UWB sensor 105 as first UWB sensor 105 passes through the obstructed pathway or space. Second UWB sensor 107 may then compute the 3D positions of first UWB sensor 105 relative to its own position based on the adjusted properties of the received (at 302) signaling.

Process 300 includes presenting (at 306) a visualization of the obstructed pathway or space from a current position of the user device. For instance, the user device may obtain an image or video feed of the obstructed pathway or space or the surface of whatever objects are obscuring the pathway or space. Alternatively, the user device may obtain a 3D model of the obstructed pathway or space and may render the 3D model at a distance, orientation, rotation, or other adjustment that compensates for an offset in the positioning between the user device and the obstructed pathway or space and the positioning that the 3D model represented the obstructed pathway or space.

Process 300 includes mapping (at 308) the 3D positions determined for first UWB sensor 105 to corresponding positions on the visualization of the obstructed pathway or space. The mapping (at 308) is performed based on a real-time tracking of the relative positions between the user device and the outer surface of the objects obscuring the pathway or space and the determined relative positions between the user device and first UWB sensor 105. For example, a determined 3D position for UWB sensor 105 may be 1 foot to the right of the user device, 5 feet in front of the user device, and 2 feet below the user device. Similarly, the user device may measure a wall that is presented in the visualization to be 4 feet in front of the user device. In this example, the user device maps (at 308) the 3D position to be 1 foot inside the visualization, 1 foot to the right of the user device, and 2 feet below the user device.

In some embodiments, the mapping (at 308) may be performed based on a relative tracked position between the user device and measurement device 100 and an identification of measurement device 100 in the visualization. For instance, the visualization may be an image of the wall with housing 103 of measurement device 100 being visible in the image. The user device may determine a relative position for housing 103 based on signaling emitted from second UWB sensor 107, and may map (at 308) the 3D positions tracked for first UWB sensor 105 relative to the identified position of measurement device 100 in the image and the difference between the 3D positions tracked for first UWB sensor 105 and the 3D position tracked for second UWB sensor 107. In some embodiments, measurement device 100 may not be visible in the image. In some such embodiments, the user device may still use the relative position of measurement device 100 as determined from the signaling of second UWB sensor 107 as a reference point from which to map (at 308) the 3D positions tracked for first UWB sensor 105 to the visualization. For instance, a user may measure and input a thickness of a wall into the user device and may specify that extendible line 101 of measurement device 100 enters through an opening about a back of the wall. The user device may use the detected position of measurement device 100, the thickness of the wall, and the identified placement of measurement device 100 at the backside of the wall as reference points for performing the mapping (at 308).

Process 300 includes updating (at 310) the visualization with a graphic showing the 3D path of first UWB sensor 105 within the obstructed pathway or space based on the mapping (at 308). In some embodiments, updating (at 310) visualization includes generating a virtual reality, augmented reality, mixed reality, or other enhanced reality presentation for the obstructed pathway or space that includes different graphical indicators for the 3D positions. In some such embodiments, the visualization may be an image of a wall or other obstructing surface. The transparency of the image may be adjusted in order to present space behind the wall or other obstructing surface and to present the tracked 3D positions at correct positions relative to the wall or other obstructing surface. In some other such embodiments, generating the visualization may include generating a 3D representation of the wall or other obstructing surface from a 2D image of the wall or other obstructing surface. Generating the 3D representation may include analyzing the image to detect edges or boundaries of the wall or other obstructing surface, and adding depth to the image by extending lines behind the wall or other obstructing surface at the detected edges or boundaries. Other 3D modeling techniques may be used to generate the 3D representation of the wall or other obstructing surface from the 2D image. For instance, a photogrammetry technique may be used to capture the wall from different sides in order to construct a 3D model of the wall. As another example, measurement device 100 may be used to measure the height, width, and thickness of the wall and to provide those measurements to the user device. The user device may use the measurements with or without the 2D image of the wall to generate a 3D model of the wall.

Measurement device 100 may supplement the 3D path visualization with additional measurements. The additional measurements may provide a precise distance, angle, and/or tilt of extendible line 101 at each of the different detected positions about the 3D path. For instance, the 3D positions derived from the UWB signaling may not provide sufficient accuracy when exact measurements are needed for construction, manufacturing, sizing, and/or other purposes. In particular, an architectural analysis of a building may require the positions of a conduit hidden in a wall with exact measurements for lengths of different conduit segments, angles at which the conduit turns, and/or distances between the conduit and different portions of the wall. The additional measurements may be generated by sensors 109 of measurement device 100.

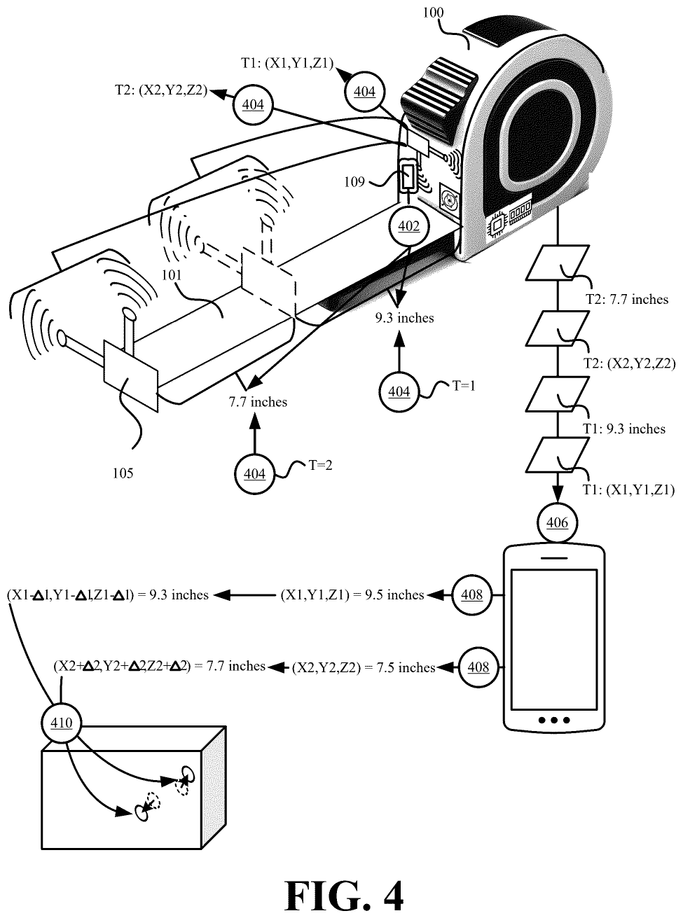

FIG. 4 illustrates an example of supplementing a measured 3D path with additional measurements in accordance with some embodiments presented herein. Sensors 109 produce the additional measurements. In particular, sensors 109 measure (at 402) the length of extendible line 101 that is pulled out from housing 103 at different times. In some embodiments, sensors 109 include lasers that reflect off a top or bottom of extendible line 101 and that are used to accurately measure the length of extendible line 101 that is pulled out from housing 103. In some embodiments, sensors 109 include an encoder that measures the length of extendible line 101 that is pulled out from housing 103. The encoder may include a spinning wheel at the opening of housing 103 that rotates as the extendible line 101 is moved into or out of housing 103. In some embodiments, sensors 109 include an accelerometer or inertial measurement unit that is located on a spool in housing 103 from which extendible line 101 is dispensed. In some such embodiments, sensors 109 measure the number of times the spool rotates as extendible line 101 is pulled out from housing 103 and converts the number of rotations to an accurate distance measurement. In some embodiments, sensors 109 account for the weight or width of the spool to compensate for greater lengths being dispensed when a starting length of extendible line 101 is pulled out from housing 103 and for lesser lengths being dispensed when an ending length of extendible line 101 is pulled out from housing 103.

Sensors 105, 107, and/or 109 may timestamp (at 404) the emitted signaling and generated measurements according to a synchronized clock. For instance, first UWB sensor 105 may include or encode a timestamp value in the signaling that is emitted, second UWB sensor 107 may timestamp each 3D position that is generated from the signaling emitted by first UWB sensor 105, and/or sensors 109 may timestamp each distance measurement.

The timestamped 3D positions and measurements may be wirelessly transmitted (at 406) from measurement device 100 to the user device using a wireless radio of measurement device 100. The user device may match the 3D positions and the distance measurements based on the associated timestamps. Specifically, the user device may use the timestamps to match a 3D position of first UWB sensor 105 at a particular time with a length or distance measurement generated by sensors 109 at the same particular time.

The user device may evaluate the matched 3D positions and distance measurements to correct (at 408) for any errors or inaccuracies in the 3D positions that were derived based solely on the UWB signaling. For instance, the derived 3D positions may have up to a 10 centimeter deviation from an actual position. The distance measurements may be used to correct for any such deviations and precisely present the 3D positions in a generated visualization of the 3D positions. Accordingly, the user device may generate (at 410) a 3D path visualization based on the 3D positions that are adjusted according to the distance measurements produced by sensors 109.

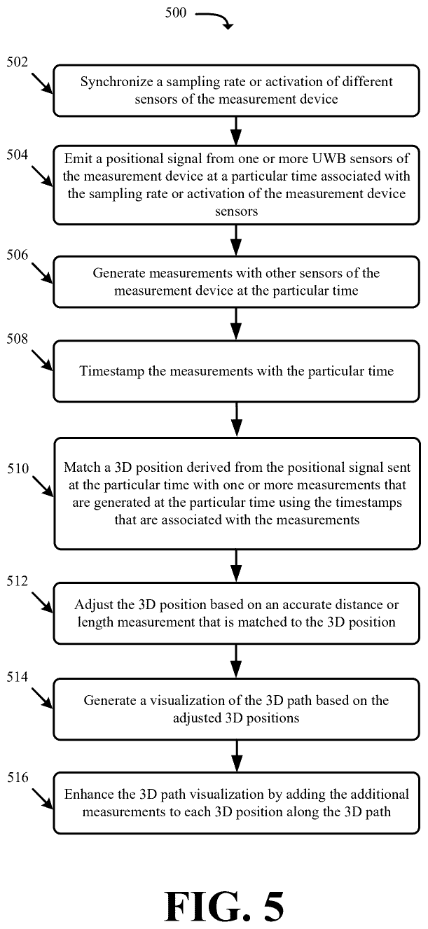

FIG. 5 presents a process 500 for improving the measurement accuracy based on different measurements produced by different sensors of measurement device 100 in accordance with some embodiments presented herein. Process 500 is implemented by the measurement system based on the coordinated operation of measurement device 100 and a user device.

Process 500 includes synchronizing (at 502) a sampling rate or activation of different sensors of measurement device 100. Synchronizing (at 502) a sampling rate or activation includes synchronizing the time at which first UWB sensor 105 and second UWB sensor 107 emit signaling for the 3D positions of the distal and proximal ends of extendible line 101 and the time at which sensors 109 generate their respective measurements. In some embodiments, measurement device 100 includes a clock that is configured to send a signal that activates each of the sensors at the same time.

Process 500 includes emitting (at 504) a positional signal from first UWB sensor 105 and second UWB sensor 107 at a particular time associated with the sampling rate or activation of the measurement device sensors, and generating (at 506) measurements with sensors 109 at the particular time. Accordingly, sensors 109 may generate a distance measurement at the same time as when first UWB sensor 105 emits signaling from a 3D position of first UWB sensor 105 at that time. The measurements generated (at 506) by sensors 109 are used to supplement or improve the accuracy of the 3D positions that are derived from the emitted (at 504) positional signals.

Process 500 includes timestamping (at 508) the measurements with the particular time. The timestamping (at 508) includes adding a value for the particular time to the measurements that were generated at the particular time. The timestamping (at 508) may also include encoding the particular time in the positional signal emitted (at 504) from first UWB sensor 105 or adding a value for the particular time in a 3D position that second UWB sensor 107 generates in response to receiving the positional signal from first UWB sensor 105. The timestamped measurements may be wirelessly transmitted from measurement device 100 to the user device after having paired the user device to measurement device 100.

Process 500 includes matching (at 510) a 3D position derived from the positional signal sent at the particular time with one or more measurements that are generated at the particular time using the timestamps that are associated with the measurements. In some embodiments, the user device may match (at 510) the most recently received positional signal with measurements that have timestamps immediately preceding the receipt time of the received signals.

Process 500 includes adjusting (at 512) the 3D position based on an accurate distance or length measurement that is matched to the 3D position. Adjusting (at 512) the 3D position includes correcting for any inaccuracy in the 3D position that is derived from the emitted (at 504) positional signal using the more accurate distance or length measurement. For instance, the derived 3D position may specify an x, y, and z position (or azimuth, distance, and altitude) that is 9.5 inches away from a last recorded position. However, the distance or length measurement output from sensors 109 may specify that extendible line 101 was extended only 9 inches from the last recorded position. Accordingly, process 500 includes adjusting (at 512) the 3D position by removing the extraneous 0.5 inches.

Process 500 includes generating (at 514) a visualization of the 3D path based on the adjusted (at 512) 3D positions. The visualization presents the 3D positions in a 3D space with or without an image or 3D model of structures or obstructions within the 3D space. The visualization may include mapping the adjusted (at 512) 3D positions to corresponding positions in an image or 3D model of the structure or environment that was measured or that first UWB sensor 105 moved through, and graphically representing the 3D positions in the image or 3D model at the corresponding positions.

Process 500 includes enhancing (at 516) the 3D path visualization of extendible line 101 by adding the additional measurements to each 3D position along the 3D path. For instance, the specific distance between two different 3D positions along the 3D path may be presented in the visualization as a numerical value. For greater specificity, the visualization may specify the exact x, y, and z positional offsets between each neighboring pair of 3D positions along the 3D path. In some embodiments, the additional measurements may be presented in response to user interactions with the 3D path or other user input. For instance, the user touch or hover over a segment of the 3D path, and the visualization may present the length of that segment. Alternatively, the user may select any arbitrary section of the 3D path, and the visualization may present the exact length of the selected section with millimeter accuracy.

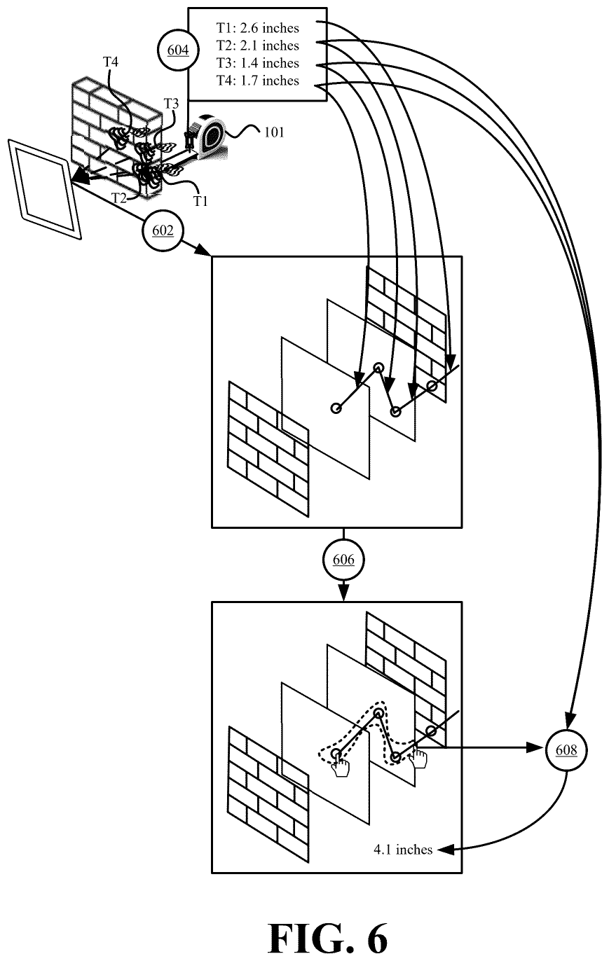

FIG. 6 illustrates an example of an enhanced visualization of a mapped 3D path through an obscured pathway or space in accordance with some embodiments presented herein. The user device determines the 3D positioning of first UWB sensor 105 as it is moved through the obscured pathway or space based on properties of the signaling received from first UWB sensor 105 at the different positions. The user device generates and presents (at 602) a visualization that illustrates the 3D path of first UWB sensor 105 through the obscured pathway or space. The user device generates (at 602) the visualization by mapping the determined 3D positions to corresponding positions about an image or model of the obscured pathway or space or an object that obscures the pathway or space, and by graphically connecting or linking the mapped 3D positions to form the visual representations of the 3D path.

The user device may also map (at 604) additional measurements that are generated at the time each 3D position is generated to the corresponding 3D position. For instance, the user device may map the exact distance between each 3D position of the 3D path.

The user device may receive (at 606) input requesting an exact length for a selected segment of the 3D path. The selected segment may begin and/or end at different positions than the 3D positions used to generate the 3D path and/or than the different lengths that were measured by sensors 109. The input may be provided via user interactions with the visualization of the 3D path. In an enhanced reality environment, the user may use their hands or figures to select the desired segment or may use controllers or other input devices to make the selection.

The user device computes in the visualization or associated user interface the exact length for the selected segment based on the exact measurements for the segments between the measured 3D positions. For a selected segment that begins in between two measured 3D positions, the user device may retrieve the exact length measurement for the segment in between the two measured 3D position, may divide the segment into equal length smaller segments until the start of the user-selected segment aligns with the start of one of the smaller segments. The user device may then determine the exact length from the start of the user-selected segment to the next 3D position, the exact length for any segments between other 3D positions in the user-selected segment, and the exact length from a last 3D position to the end of the user-selected segment via a similar approach of dividing the last the segment as the first segment. The user device presents (at 608) the exact length for the user-selected segment in the visualization or in an associated user interface.

In some embodiments, signaling from the UWB sensors of two or more measurement devices 100 may be used in combination in order to determine the volume of a space. Rather than take one measurement of one wall and move measurement device 100 to another wall to take another measurement, the two or more measurement devices 100 may be positioned along each wall of the space being measured, and a collective reading of the signaling the two or more measurements 100 may be used to determine the volume of the space.

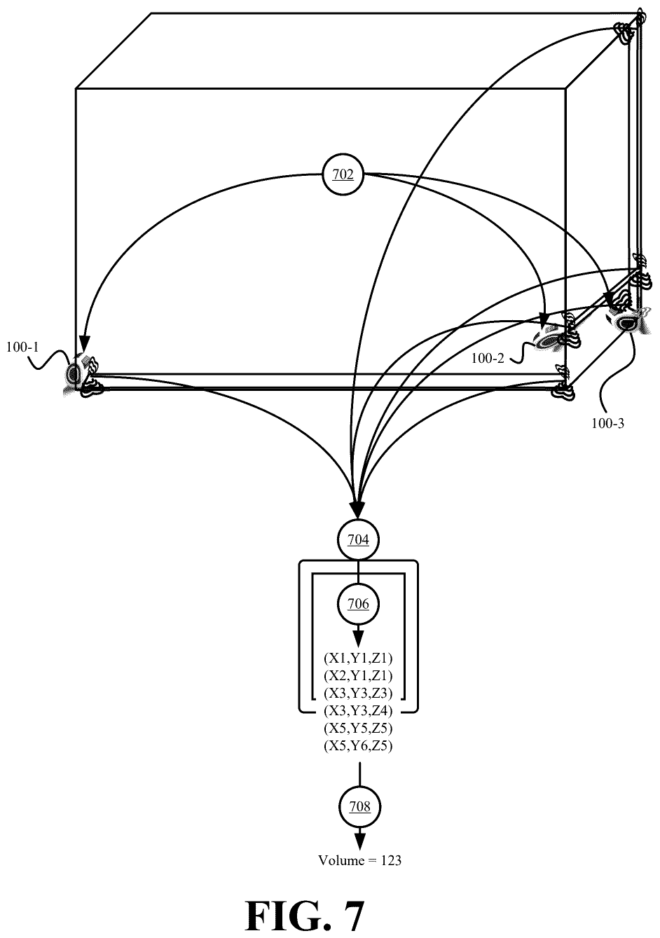

FIG. 7 illustrates an example of using different measurement devices 100 to calculate a single value for a space in accordance with some embodiments presented herein. As shown in FIG. 7, a user may position (at 702) first measurement device 100-1 along a first axis of a first wall of a particular space, second measurement device 100-2 along a second axis of a second wall of the particular space, and third measurement device 100-3 along a third axes of any of the first, second, or another wall of the particular space.

A user device positioned anywhere inside or outside the rectangular space may pair with each of first measurement device 100-1, second measurement device 100-2, and third measurement device 100-3. Once paired or connected, the user device receives (at 704) the signaling from UWB sensors of first measurement device 100-1, second measurement device 100-2, and third measurement device 100-3. The user device converts (at 706) the measurements into 3D positions, and computes (at 708) the volume of the particular space based on the 3D positions.

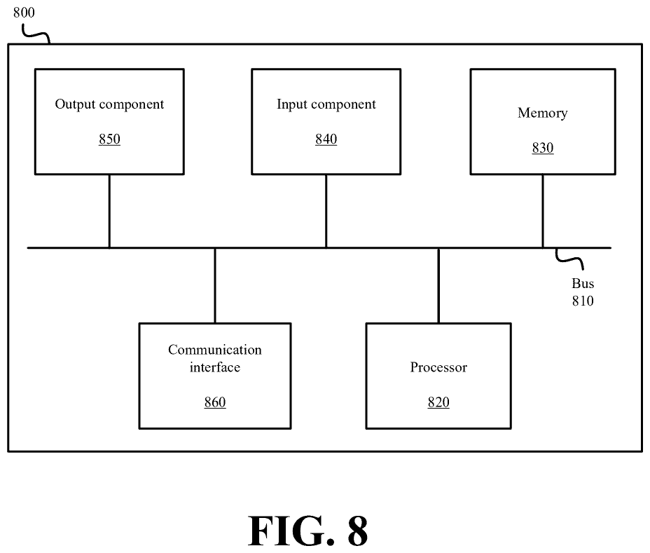

FIG. 8 is a diagram of example components of device 800. Device 800 may be used to implement one or more of the devices or systems described above (e.g., the measurement system, measurement device 100, the user devices, etc.). Device 800 may include bus 810, processor 820, memory 830, input component 840, output component 850, and communication interface 860. In another implementation, device 800 may include additional, fewer, different, or differently arranged components.

Bus 810 may include one or more communication paths that permit communication among the components of device 800. Processor 820 may include a processor, microprocessor, or processing logic that may interpret and execute instructions. Memory 830 may include any type of dynamic storage device that may store information and instructions for execution by processor 820, and/or any type of non-volatile storage device that may store information for use by processor 820.

Input component 840 may include a mechanism that permits an operator to input information to device 800, such as a keyboard, a keypad, a button, a switch, etc. Output component 850 may include a mechanism that outputs information to the operator, such as a display, a speaker, one or more light emitting diodes (“LEDs”), etc.

Communication interface 860 may include any transceiver-like mechanism that enables device 800 to communicate with other devices and/or systems. For example, communication interface 860 may include an Ethernet interface, an optical interface, a coaxial interface, or the like. Communication interface 860 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 800 may include more than one communication interface 860. For instance, device 800 may include an optical interface and an Ethernet interface.

Device 800 may perform certain operations relating to one or more processes described above. Device 800 may perform these operations in response to processor 820 executing software instructions stored in a computer-readable medium, such as memory 830. A computer-readable medium may be defined as a non-transitory memory device. A memory device may include space within a single physical memory device or spread across multiple physical memory devices. The software instructions may be read into memory 830 from another computer-readable medium or from another device. The software instructions stored in memory 830 may cause processor 820 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

The actual software code or specialized control hardware used to implement an embodiment is not limiting of the embodiment. Thus, the operation and behavior of the embodiment has been described without reference to the specific software code, it being understood that software and control hardware may be designed based on the description herein.

For example, while series of messages, blocks, and/or signals have been described with regard to some of the above figures, the order of the messages, blocks, and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations described herein may be described in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more. ” Where only one item is intended, the terms “one,” “single,” “only,” or similar language is used. Further, the phrase “based on” is intended to mean “based, at least in part, on” unless explicitly stated otherwise.

1. A method for tracking a three-dimensional (3D) path within an obscured pathway or space, the method comprising:
receiving, at a user device, signaling from a wireless transceiver that is moved to different positions within the obscured pathway or space;
converting the signaling into a plurality of 3D positions based on properties of the signaling changing upon arrival at the user device from the different positions;
mapping the plurality of 3D positions to corresponding positions about an image or a 3D model of the obscured pathway or space; and
presenting a visualization of the 3D path comprising graphical indicators at the corresponding positions about the image or the 3D model.

2. The method of claim 1,
wherein converting the signaling comprises:
determining a 3D position of the wireless transceiver relative to the user device based on the properties of the signaling emitted from the wireless transceiver at a particular time; and
wherein mapping the plurality of 3D positions comprises:
determining a position of the obscured pathway or space relative to the user device; and
determining a particular corresponding position about the image or the 3D model based on a difference between the 3D position of the wireless transceiver relative to the user device and the position of the obscured pathway or space relative to the user device.

3. The method of claim 1, wherein converting the signaling comprises:
determining an azimuth, distance, and altitude of the wireless transceiver relative to the user device as the wireless transceiver emits the signaling from the different positions.

4. The method of claim 1, wherein presenting the visualization comprises:
generating an enhanced reality view of the obscured pathway or space with a graphical representation of the 3D path passing in three dimensions through the obscured pathway or space.

5. The method of claim 1 further comprising:
receiving a set of distance measurements with timestamps; and
matching each distance measurement from the set of distance measurements to a different 3D position from the plurality of 3D positions based on the timestamps.

6. The method of claim 5 further comprising:
adjusting the plurality of 3D positions in response to a distance between two adjacent 3D positions from the plurality of 3D positions differing from the distance measurements matched to the two adjacent 3D positions.

7. The method of claim 5 further comprising:
presenting each particular distance measurement from the set of distance measurements in the visualization next to a segment of the 3D path for a 3D position that is matched to that particular distance measurement.

8. The method of claim 5 further comprising:
receiving a user input for selecting a segment of the 3D path;
calculating a distance of the segment in response to determining a subset of 3D positions from the plurality of 3D positions spanned by the segment and the matching of the distance measurement to each 3D position in the subset of 3D positions; and
presenting the distance of the segment in the visualization in response to the user input.

9. The method of claim 1, wherein presenting the visualization comprises:
connecting the graphical indicators with lines extending between the corresponding positions.

10. The method of claim 1, wherein the different positions within the obscured pathway or space are not visible to a human eye, and wherein the visualization reveals the different positions on a display of the user device.

11. The method of claim 1, wherein the visualization provides a real-time view for a position of the wireless transceiver in the obscured pathway or space on a display of the user device.

12. The method of claim 1, wherein the visualization graphically tracks the 3D path of the wireless transceiver through the obscured pathway or space.

13. A measurement system for tracking a three-dimensional (3D) path within an obscured pathway or space, the measurement system comprising:
a measurement device comprising a wireless transceiver on a distal end of an extendible line; and
a user device comprising one or more hardware processors configured to:
receive signaling from the wireless transceiver that is moved to different positions within the obscured pathway or space;
convert the signaling into a plurality of 3D positions based on properties of the signaling changing upon arrival at the user device from the different positions;
map the plurality of 3D positions to corresponding positions about an image or a 3D model of the obscured pathway or space; and
present a visualization of the 3D path comprising graphical indicators at the corresponding positions about the image or the 3D model.

14. The measurement system of claim 13,
wherein converting the signaling comprises:
determining a 3D position of the wireless transceiver relative to the user device based on the properties of the signaling emitted from the wireless transceiver at a particular time; and
wherein mapping the plurality of 3D positions comprises:
determining a position of the obscured pathway or space relative to the user device; and
determining a particular corresponding position about the image or the 3D model based on a difference between the 3D position of the wireless transceiver relative to the user device and the position of the obscured pathway or space relative to the user device.

15. The measurement system of claim 13, wherein converting the signaling comprises:
determining an azimuth, distance, and altitude of the wireless transceiver relative to the user device as the wireless transceiver emits the signaling from the different positions.

16. The measurement system of claim 13, wherein presenting the visualization comprises:
generating an enhanced reality view of the obscured pathway or space with a graphical representation of the 3D path passing in three dimensions through the obscured pathway or space.

17. The measurement system of claim 13, wherein the one or more hardware processors are further configured to:
receive a set of distance measurements with timestamps; and
match each distance measurement from the set of distance measurements to a different 3D position from the plurality of 3D positions based on the timestamps.

18. The measurement system of claim 17, wherein the one or more hardware processors are further configured to:
adjust the plurality of 3D positions in response to a distance between two adjacent 3D positions from the plurality of 3D positions differing from the distance measurements matched to the two adjacent 3D positions.

19. The measurement system of claim 17, wherein the one or more hardware processors are further configured to:
present each particular distance measurement from the set of distance measurements in the visualization next to a segment of the 3D path for a 3D position that is matched to that particular distance measurement.

20. A non-transitory computer-readable medium storing instructions that, when executed by one or more processors of a measurement system, cause the measurement system to perform operations comprising:
receiving signaling from a wireless transceiver that is moved to different positions within an obscured pathway or space;
converting the signaling into a plurality of three-dimensional (3D) positions based on properties of the signaling changing upon arrival at a user device from the different positions;
mapping the plurality of 3D positions to corresponding positions about an image or a 3D model of the obscured pathway or space; and
presenting a visualization comprising graphical indicators at the corresponding positions about the image or the 3D model.
